(19) United States
(12) Patent Application Publication
(10) Pub. No.: US 2004/0177154 A1
(43) Pub. Date: Sep. 9, 2004

(54) Method for trasmitting service data, network element and communications system

(76) Inventors: Sinikka Sarkkinen, Kangasala (FI); Jari Tossavainen, Vantaa (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/483,519

(22) PCT Filed: Jul. 11, 2001
(86) PCT No.: PCT/EP01/07997

(51) Int. Cl. G06F 15/16

(52) U.S. Cl. 709/236

(57) ABSTRACT

The invention relates to a method for transmitting data for a specific service from a first network element 5 of a communications network via at least a second network element 10 of a communications network to a group of terminals 13, wherein said first network element 5 receives said data for said specific service from a service provider 1-4. In order to enable larger data or data with a longer life time, it is proposed that the first network element 5 distributes said data for said specific service to one or more packets for transmission to said at least second network element 10. Further, the first network element 5 provides each of said one or more packets with a data flow identification information which enables said at least second network element 10 to identify all received packets to which said data for said specific service was distributed.

### CROSS-REFERENCE TO RELATED APPLICATION

This application is the U.S. National Stage of International Application Number PCT/EP01/07997 filed Jul. 11, 2001 which was published in English Jan. 23, 2003 under International Publication No. WO 03/007635 A1 and from which priority is claimed.

### FIELD OF THE INVENTION

The invention relates to a method for transmitting data for a specific service from a first network element of a communications network via at least a second network element of a communications network to a group of terminals, wherein said first network element receives said data for said specific service from a service provider. The invention relates equally to corresponding network elements and to a corresponding communications system.

### BACKGROUND OF THE INVENTION

Transmissions of data from a first network element via a second network element to a group of terminals are employed in particular for cell broadcast services (CBS) or for multicast services in communications systems.

CBS messages are cell broadcast messages to defined geographical areas which comprise one or more cells of a communications system. The geographical area can be defined separately for each CBS message.

For CBS, small data packets of 1246 bytes are transmitted in each selected cell on a FACH (Forward Access Channel) channel assigned for cell broadcast type of data transmission after the segmentation on layer 2 (L2) by the Radio Link Controller (RLC) to the predetermined size, which is defined by layer 3 (L3). All terminals in one of the selected cells can receive the data packets over the air interface by listening to an SCCPCH (Secondary Common Control Physical Channel) which contains such a FACH channel. The use of the service by the user of a terminal does not have to be indicated to the network, i.e. also idle mode terminals can use the service and therefore also no feedback channel is required. Further, no ciphering is performed to the data, and the users of the service cannot be charged, therefore the service provider has to pay for the service. A service type which could typically use the cell broadcast concept is small advertisements from shopkeepers, short news, road services etc.

Multicast services have been proposed in addition for more sophisticated transmissions, in particular in UMTS and GPRS. Multicast services can be employed for offering services only to terminal users who ordered a specific service from a service provider. This can be achieved e.g. by applying a ciphering to the data which is to be transmitted, ensuring that only subscribed terminal users are able to use received data. The service is thus not available for all users in the cell. Depending on the agreement, the service can then be charged either to the subscribed users or to the service provider. The proposed multicast service is similar to a data transmission from one service provider to a restricted group of users by using method defined for broadcast transmissions.

Before a message can be transmitted to terminals, though, it has to be transmitted from the service provider to the selected cells, and thus between different network elements of connecting communications networks. According to the technical specification 3GPP TS 23.041 V3.4.0 (2001-06): “3rd Generation Partnership Project; Technical Specification Group Terminals; Technical realization of Cell Broadcast Service (CBS) (Release 1999)”, a cell broadcast center CBC is provided as a first defined network element responsible for receiving and forwarding data from service providers. For GSM (Global System for Mobile communications), the CBC transmits the data in a an SABP (Service Area Broadcast Protocol) Write-Replace message of one CBC PDU (Protocol Data Unit) to one or more BSCs (base station controller) as second network elements. The respective BSC then transmits the data via base stations over the air interface to terminals of the respective cell. For UMTS (Universal Mobile Telecommunications System), the CBC as a defined first network element transmits the data in a an SABP (Service Area Broadcast Protocol) Write-Replace message of one CBC PDU (Protocol Data Unit) over the Iu-BC interface to one or more RNCs (radio network controller) of one or more UTRANs (UMTS Terrestrial Radio Access Network) as second network elements. The respective RNC then transmits the data in packets, which size is defined by L3, on a FACH via node Bs to terminals. Since in UMTS the CBC is part of the core network, a mandatory protocol between CBC and RNC has to be used. For UTRAN, the transmissions for CBSs from a CBC to an RNC are specified in the technical specification 3GPP TS 25.419 V3.4.0 (2001-03): “3rd Generation Partnership Project; Technical Specification Group RAN; UTRAN Iu-BC Interface: Service Area Broadcast Protocol SABP (Release 1999)”.

The current specifications of Cell Broadcast services allow the transmission of a CBS message, comprising the service, between the CBC and RNC or BSC in a single data packet with 1246 bytes of data at maximum. The transmission in a single data packet moreover implies that all data belonging to one service has to be present in the CBC before the CBC forwards the PDUs to the RNC or BSC. This restricts the use of Cell Broadcast to such services which require a total data amount of 1246 bytes at the most, or of which the life time is so small that the buffering of all data in CBC first is acceptable from the delay point of view, thus excluding e.g. video streams, music clips etc.

### SUMMARY OF THE INVENTION

It is an object of the invention to enable an improved transmission of data directed at a group of terminals of a communications system. It is in particular an object to allow the transmission of messages containing more data and of messages with a longer life-time between network elements of the communications system.

This object is reached according to the invention with a method for transmitting data for a specific service from a first network element of a communications network via at least a second network element of a communications network to a group of terminals, wherein the first network element receives the data for the specific service from a service provider, and wherein the first network element distributes the data for the specific service to one or more packets for transmission to the at least second network element. It is further proposed that the first network element provides each of the one or more packets with a data flow identification information. This information enables the at least second network element to identify all received packets to which the service data was distributed.

The service provider can be on the one hand an individual person, a community, a club, a company, a government, or any other entity who does not own the network. On the other hand, the service provider can be the operator who owns the network. The kind of service provider may have an influence on the direction from which the data is provided to the first network element. The group of terminals to which the service data is to be transmitted can comprise one or more terminals. For multicast services the number will depend e.g. on the number of subscribers. The data can moreover reach the terminals of the group via a single second network element or via several second network elements.

The object of the invention is equally reached with a corresponding first network element, with a corresponding second network element, and with a communications system comprising at least one such first and one such second network element.

The invention proceeds from the idea that a service data flow can be longer or more extended in time, if it does not have to be transmitted in a single packet as currently specified for cell broadcast messages, but can be distributed to a plurality of packets. In order to enable a second network element to process a plurality of received packets comprising a service data flow correctly, it is further proposed that an additional information is included in the packets to which the service data flow is distributed. This additional information can be used in the second network element to identify all packets belonging to a single service data flow.

The invention thus enables on the one hand to support services of which the total data amount exceeds 1246 bytes. On the other hand, it enables to support services which total life time makes a buffering of data in the first network element of the communications system impractical.

The data flow identification information can always be included in each packet to which the data is distributed.

Alternatively, the data flow identification information may only be included in each packet whenever the information is needed, i.e. when the data was distributed to more than one packet.

Preferred embodiments of the invention become apparent from what follows.

In a preferred embodiment of the invention, the first network element distributing a data flow of one service to different packets is a CBC. The CBC advantageously receives the data flow from some service providers application. In case the first network element is a CBC, the packets can be CBC PDUs transmitted over an Iu-BC interface. In particular the SABP-Write-Replace messages of CBC PDUs can be employed for including the data for a specific service.

In an equally preferred embodiment of the invention, the at least one second network element comprises one or more UTRAN-RNCs and/or one or more GSM-BSCs. But the invention can equally be realized with any other suitable network element, even with a base station or a media gateway etc.

The content of the new data flow identification information is included preferably in a data flow identification field. The information can be structured in any suitable way and comprise in addition to an identification of the data flow a variety of other information.

The data flow identification information can comprise in particular a flow number. If a separate flow number is assigned to each service, this enables the second network element in an easy way to identify all packets belonging to the data flow of a specific service.

Another information which might be included in the data flow identification information is an indication of the length of the service, e.g. in terms of bits or bytes belonging to the same flow. The number can be defined as the total amount of data in a corresponding data flow, or as a calculated value of data still to be transmitted by the first network element.

The data flow identification information can further comprise as similar value an indication of the number of packets belonging to the same data flow. The number can indicate the total number of packets, and in this case the value of the indication would be the same in all packets belonging into the same data flow. Alternatively, such a value of the data flow identification information can indicate how many packets are still in the buffer of the first network element, i.e. the value of the indication is decreased each time when another packet is sent.

Moreover, the data flow identification information can comprise an identifier which indicates the end of the data flow. For instance, a value x could indicate that the respective packet is not the last packet belonging to a specific data flow, and a value y could indicate that the respective packet is the last packet belonging to a specific data flow.

Furthermore, the data flow identification information may contain a start indicator for data, which is included in the first packet in the flow to indicate the start of new data flow. The data flow identification information may also contain a length indicator for data, which is used only in the last packet to indicate the end of the data flow for the same service. Preferably, such a length indicator indicates the location of the last byte in the last packet. Start and length indicator could share the same position in the data flow identification information.

The proposed distribution of a data flow of a single service to several packets can be employed based on the currently specified maximum data size of 1246 bytes per packet.

Alternatively, the conventional packet size of 1246 could in addition be increased, or a second kind of PDUs with a size of e.g. a multiple of 1246 bytes could be introduced. It has to be taken into account, however, that the packet length has some optimum value depending on the application. If the packet is too short, overhead increases. If the packet is too long, reliability and real time aspects suffer.

In a further preferred embodiment of the invention, also data of a total amount of less than the available data space in one packet, e.g. 1246 bytes, can be distributed to several packets for transmission from the first network element to the second network element. Currently, if there is a plurality of small application level SDUs (Service Data Units), these are combined into a single CBC PDU. By providing a possibility of distributing such data to a plurality of packets, the required buffering capacity of the CBC or other first network elements can be decreased and the delay of the data be reduced.

The proposed invention can be employed in particular for cell broadcast services and for multicast services.

The proposed invention can moreover be employed in particular, though not exclusively, in GPRS and UMTS.

### BRIEF DESCRIPTION OF THE DRAWINGS

In the following, the invention is explained in more detail with reference to drawings, of which

FIG. 1 shows an architecture supporting the service according to the invention;

FIG. 2 is a table taken from specification TS 25.419 and illustrates the current structure of a Write-Replace message; and

FIG. 3 is a table illustrating an embodiment of a structure of a Write-Replace message according to the invention.

### DETAILED DESCRIPTION OF THE INVENTION

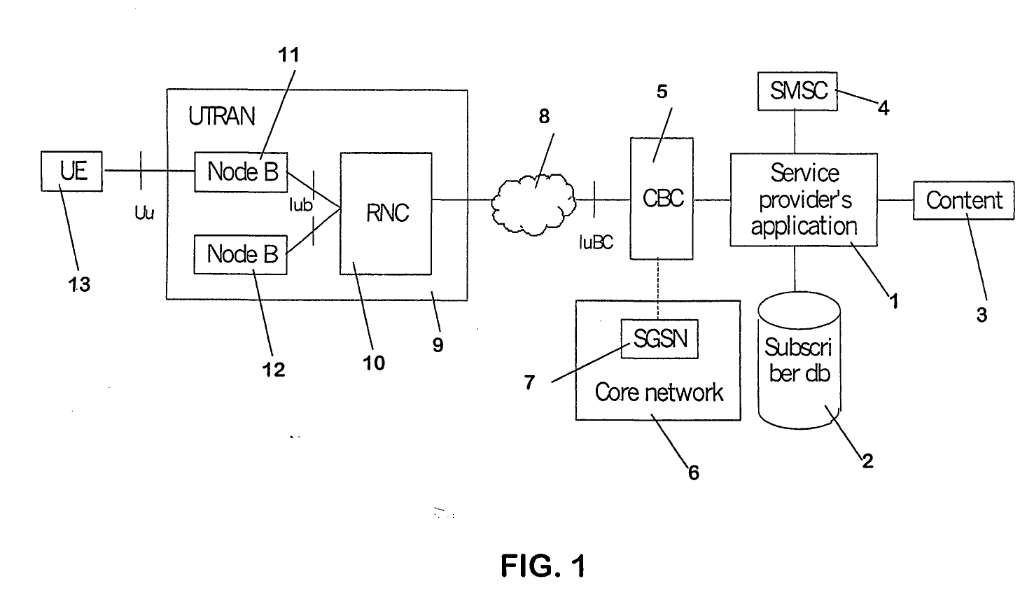

FIG. 1 shows an embodiment of a UMTS network architecture which can be employed for cell broadcast or multicast services according to the invention.

The architecture comprises a service provider's application 1 which has access to a subscriber data base 2, to a content data base 3 and to a short message service center SMSC 4. The service provider's application 1 is further connected to a cell broadcast center CBC 5. The CBC 5 is part of the core network 6 and connected to a routing node, e.g. a 3G (third generation) Serving GPRS Support Node SGSN 7, via a Bc reference point.

The CBC 5 is connected in addition via the IuBC interface and an interconnecting network 8 to one or more RNCs of one or more UTRANs. In FIG. 1, only a connection to a single RNC 10 of a single UTRAN 9 is shown. The RNC 10 is connected within the UTRAN 9 to a plurality of Node Bs 11, 12. In the situation depicted in FIG. 1, a user equipment UE 13 moreover accesses one of the node Bs 11 via the air interface Uu.

In case the service provider wants to provide a specific service by sending out a multicast message, the service provider's application 1 assembles information from the subscriber data base 2 and the content data base 3. From the subscriber data base 2 information is retrieved about the subscribers to whom the message is to be transmitted, indicating for example the cells in which the message has to be transmitted. From the content data base 3 the data for the desired service is retrieved. The data for the desired service is ciphered in a way that can only be deciphered by subscribing terminals. The assembled information is then forwarded by the service provider's application 1 to the CBC 5. The SMSC 4 connected to the service provider's application 1 is a possible service source for services requiring up to 1246 bytes. The CBC 5 is responsible for the management of cell broadcast service messages. The CBC 5 prepares CBC PDUs for transmitting service data to the RNC 10, each PDU comprising a SABP Write-Replace message. Each SABP Write-Replace message is designed to comprise service data of up to 1246 bytes, and according to the invention, the data for a single service can be distributed to the SABP Write-Replace messages of several PDUs, in case the size of the data exceeds 1246 bytes. The number of the PDUs provided by the CBC 5 for one service thus depends on the size of the service data that is to be transmitted. Each SABP Write-Replace message comprises in addition to the service data different parameters. According to the invention, one of these parameters is a data flow identifier included in a data flow identification field of each SABP Write-Replace message. This field identifies in all messages and thus in each PDU the data flow belonging to a single service.

The CBC 5 forwards the prepared CBC PDU via the Iu-BC interface and the interconnecting network 8 to the RNC 10 of the depicted UTRAN 9. The RNC 10 receives the CBC PDUs, and based on the included data flow identification field it is able to identify all packets comprising data of a single service. This knowledge is then used by the RNC 10 to forward the data in a suitable way to terminals 13. The kind of transmission to the terminals employed by the RNC 10 may depend on a threshold value for the number of subscribing terminals in the cell of the RNC 10. Below the threshold value the RNC 10 can employ point-to-point transmissions, and above the threshold value the RNC 10 can employ point-to-multipoint transmissions. For point-to-multipoint transmissions, the RNC 10 assembles CBS messages including the service data and selected additional information of the Write-Replace messages. These CBS messages are inserted as small packets to a FACH of a SCCPCH, which is transmitted via node B 11 over the air interface Uu.

The user equipment 13 listens to the SCCPCH and is thus able to retrieve the small packets from the FACH in which they were included. If the user equipment 13 is able to decipher the data in the small packets, it presents the deciphered data to the user.

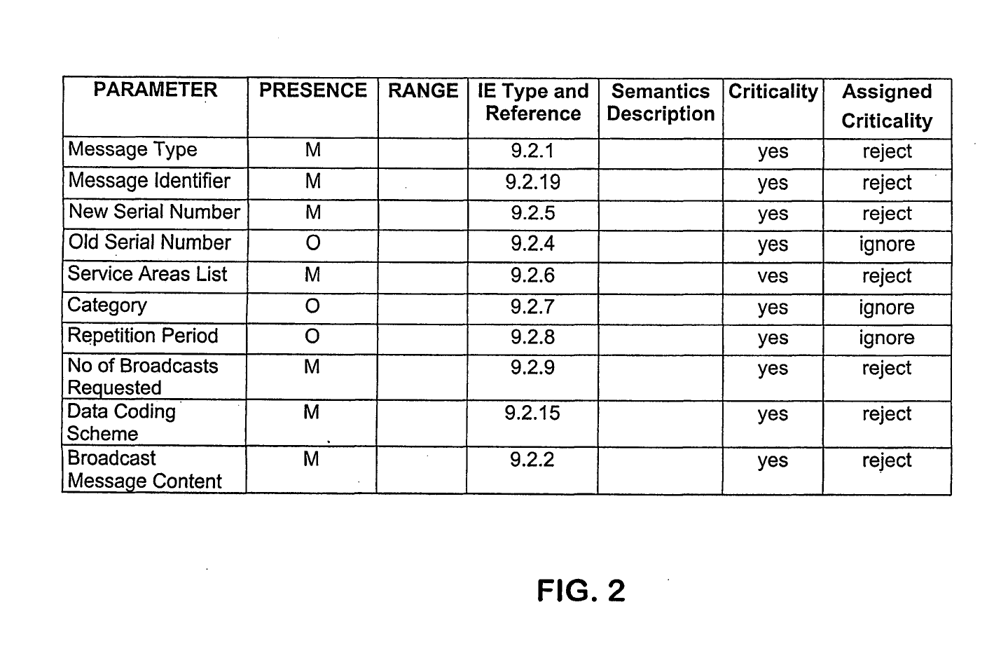

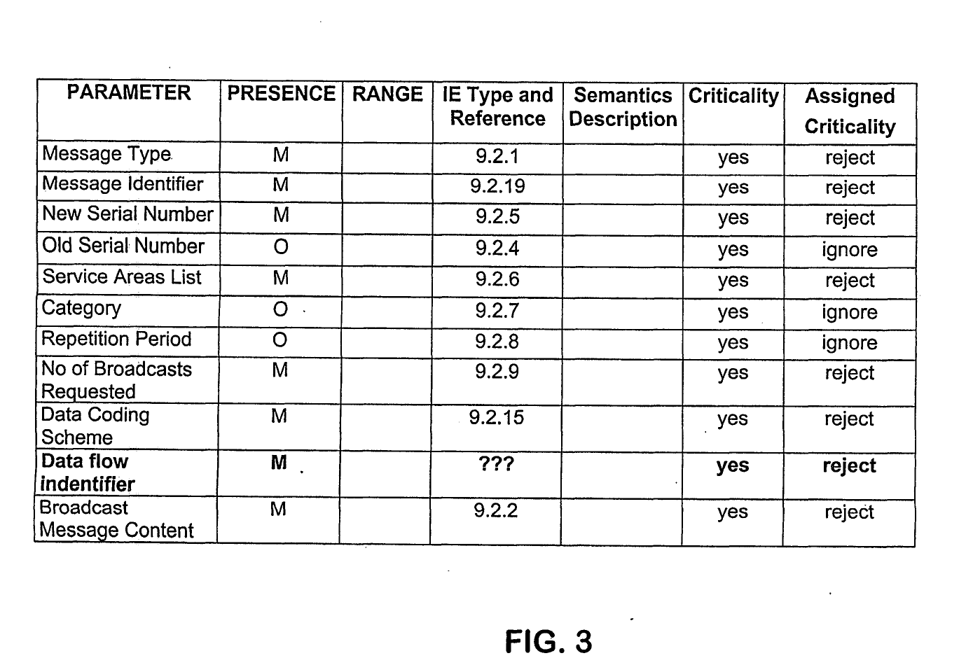

In the following, the SABP Write-Replace message employed in the network architecture of FIG. 1 for transmitting service data and other parameters will be described in more detail with reference to FIGS. 2 and 3. The SABP Write-Replace message is one of several Elementary Procedures EPs of a SABP, which EPs form units of interaction between the CBC and the RNC. These EPs are defined separately and are intended to be used to build up complete sequences in a flexible manner. An EP consists of an initiating message and possibly a response message.

It is one of the tasks of the Write-Replace message to broadcast new information to a selected Service Area, or to replace a message already broadcast. The structure of a conventional SABP Write-Replace message is depicted in the table of FIG. 2, which was taken from the above mentioned specification TS 25.419. The message is specified for broadcast messages, but can be used equally or similarly for multicast messages. The message contains several fields each associated to a specific parameter. Each field contains various information for the respective parameter. The table assigns in columns different values of this information to the different parameters.

The first field for a parameter “Message Type” uniquely identifies the transmitted message. It is mandatory for all messages. The second field for a parameter “Message Identifier” is set by the core network and transferred transparently to the user equipment. It identifies the source and type of the CBS Message. This information can be used by the user equipment to search only for specific messages. A field for a parameter “New Serial Number” enables the identification of a new broadcast message, and is altered every time the message is changed. A field for a parameter “Old Serial Number” enables an identification of an existing message. A further field for a parameter “Service Areas List” indicates the group of Service Area(s) that the message will be broadcast to. Another field is provided for a parameter “Category” and is used to indicate the priority of a message. A field for a parameter “Repetition Period” indicates the periodicity of message broadcasts, and a field for a parameter “No of Broadcasts Requested” indicates the number of times a message is to be broadcast. A field for a parameter “Data Coding Scheme” moreover identifies the alphabet or coding employed for the message characters and message handling at the user equipment. This field is passed transparently from the core network to the user equipment. Finally, a last field for a parameter “Broadcast Message Content” is sent from the core network to the RNC containing the user information, i.e. the data for one service of up to 1246 bits, and will be broadcast over the radio interface. The respective information is contained in all fields in an information element IE.

One value of additional information in each field relates to the presence of the parameter, which can be a mandatory parameter, indicated by “M”, or optional, indicated by “O” in the second column of the table in FIG. 2. Another value is the range of the respective parameter, which indicates the allowed number of copies of repetitive IEs or IE (Information Element) groups. A column “IE Type and Reference” then indicates the section in the specification defining the respective parameter. A further column comprises the “semantics description” for the respective parameter. Another information is the “criticality”, indicating whether in the SABP messages there is criticality information set for individual IEs and/or groups of IEs. This criticality information is included in the last column “assigned criticality” and instructs the receiver how to act when receiving an IE or an IE group that is not comprehended. In the exemplary table of FIG. 2, this assigned criticality is either reject or ignore for the different parameters. The range, the IE Type and the semantics description are not included in the table. They can be taken in detail from the specification for the different parameters.

The conventional structure of the SABP Write-Replace message illustrated in the table of FIG. 2 is supplemented according to the invention by a field for an additional parameter. This is indicated in FIG. 3, which presents the same table as FIG. 2, except that a data flow indication field for a new parameter was added. The new parameter is referred to in the table as “data flow identifier” and the corresponding new field is accentuated by shading. In the presented embodiment of the Write-Replace message, the new parameter is mandatory, and in case of criticality, the respective PDU is to be rejected by the RNC. The IE of the parameter identifies the association between the PDUs belonging to the same service data flow. This can be achieved for example by a flow number assigned to each service, which flow number is included in the IE of the data flow identification field of all Write-Replace messages employed for a single data flow. Only with such an additional information, the data of a single service message which was distributed to several Write-Replace messages can be processed correctly.

The additional data flow identification field may further include a variety of other information supporting the RNC in processing the PDUs correctly.

Referring back to FIG. 1, the network element 5 includes various parts which allow it to operate in a communications network. Most of these parts take the form of well known electronic parts which may include for instance integrated circuits, signal processors, central processing units, various forms of memory, input/output ports, etc., all interconnected by data, control and address busses. Usually there are one or more computer programs stored in the form of coded instructions in one or more of the various memories of the device 5. The one or more programs allow the network element to carry out its various functions. In addition, the network element 5 is augmented to include means for carrying out functions of the present invention and these functions may also be carried out by coded instructions stored in memory. It should be realized, however, that the means used to carry out the functions of the present invention may take various forms of hardware, software, or both. For instance, the network element 5 may include a device 5A for receiving data for a specific service from a service provider 1-4, which data is to transmitted to a group of terminals including the terminal 13 via at least the second network element 10 of the communications network shown in FIG. 1. It may also include means 5B for distributing the data for the specific service to one or more packets for transmission to the at least second network element 10 and for providing each of the packets with a data flow identification information which enables the at least second network element 10 to identify all received packets to which the data or the specific service was distributed. Furthermore, the network element 5 may also include a device 5C for transmitting the packets to the at least second network element 10. As mentioned above, the network element 5 may be a cell broadcast center (CBC).

FIG. 1 also shows details of functions which may be carried out in the RNC 10 for carrying out the present invention. These include a receiver 10a for receiving from another network element 5 packets to which data for a specific service was distributed at the other network element 5 upon receipt of the data for a specific service from the service provider 1-4, wherein each of the packets comprises a data flow identification information identifying all packets to which data for the specific service was distributed. The network element 10 may also include an extraction device 10B for extracting the data flow identification information from each received packet containing such a data flow identification information as well as another device 10C for forwarding the data for a specific service in accordance with the extracted information to a group of terminals including the terminal 13 of FIG. 1. The network element 10 may for instance be an RNC, as mentioned above, or a base station controller or any other kind of network element.

1. Method for transmitting data for a specific service from a first network element (5) of a communications network via at least a second network element (10) of a communications network to a group of terminals (13), wherein said first network element (5) receives said data for said specific service from a service provider (1-4), wherein said first network element (5) distributes said data for said specific service to one or more packets for transmission to said at least second network element (10), and wherein said first network element (5) includes in each of said one or more packets a data flow identification information which enables said at least second network element (10) to identify all received packets to which said data for said specific service was distributed.

2. Method according to claim 1, wherein said data flow identification information comprises a specific flow number assigned to said specific service.

3. Method according to claim 1, wherein said data flow identification information comprises an indication of the length of said data of a specific service.

4. Method according to claim 1, wherein said data flow identification information comprises an indication of the number of packets belonging to said data for said specific service.

5. Method according to claim 1, wherein said data flow identification information comprises an identifier which indicates the end of said data for said specific service.

6. Method according to claim 1, wherein said data flow identification information comprises in the first packet to which said data for said specific service is distributed a start indicator indicating the start of new data for a new specific service.

7. Method according to claim 1, wherein said data flow identification information comprises in the last packet to which said data is distributed a length indicator for data for a specific service, which length indicator indicates the end of said data in said last packet for said specific service.

8. Method according to claim 1, wherein data for a specific service of a total amount which is smaller than an amount for which space is available for such data in a single one of said packets is distributed by said first network element (5) to at least two packets for transmission to said at least one second network element (10).

9. Method according to claim 1, wherein each of said packets to which said data for said specific service is distributed comprises up to 1246 bytes for said data for said specific service.

10. Method according to claim 1, wherein at least some of said packets to which said data for said specific service is distributed is allowed to comprise more than 1246 bytes for said data for said specific service.

11. Method according to claim 1, wherein said first network element (5) is a cell broadcast center (CBC).

12. Method according to claim 1, wherein said at least second network element (10) comprises at least one radio network controller (RNC) and/or at least one base station controller (BSC).

13. Method according to claim 1, wherein said one or more packets in which said data for a specific service and said data flow identification information are included for transmission from a first network element (5) to at least a second network element (10) are protocol data units (PDU).

14. Method according to claim 13, wherein said data for a specific service and said data flow identification information are included in a respective service area broadcast protocol (SABP) Write-Replace message of cell broadcast controller (CBC) protocol data units (PDU), each Write-Replace message being provided with a dedicated data flow identification field for including said data flow identification information.

15. Method according to claim 1, wherein said specific service is a specific cell broadcast service.

16. Method according to claim 1, wherein said specific service is a specific multicast service.

17. Network element (5) for a communications network, comprising
means for receiving data for a specific service from a service provider (1-4), which data is to be transmitted to a group of terminals (13) via at least a second network element (10) of a communications network;
means for distributing said data for said specific service to one or more packets for transmission to said at least second network element (10) and for providing each of said packets with a data flow identification information which enables said at least second network element (10) to identify all received packets to which said data for said specific service was distributed; and
means for transmitting said packets to said at least second network element (10).

18. Network element (5) according to claim 17 which is a cell broadcast center (CBC).

19. Network element (10) of a communications network, comprising
receiving means for receiving from another network element (5) packets to which data for a specific service was distributed at said other network element (5) upon receipt of said data for a specific service from a service provider (1-4), wherein each of said packets comprises a data flow identification information identifying all packets to which data for said specific service was distributed;
means for extracting said data flow identification information from each received packet containing such a data flow identification information; and
means for forwarding the data for a specific service in accordance with said extracted information to a group of terminals (13).

20. Network element (10) according to claim 19 which is a radio network controller (RNC) or a base station controller (BSC).

21. Communications network, which comprises at least one network element (5) according to claim 17 and at least one network element (10) comprising
receiving means for receiving from another network element (5) packets to which data for a specific service was distributed at said other network element (5) upon receipt of said data for a specific service from a service provider (1-4), wherein each of said packets comprises a data flow identification information identifying all packets to which data for said specific service was distributed;
means for extracting said data flow identification information from each received packet containing such a data flow identification information; and
means for forwarding the data for a specific service in accordance with said extracted information to a group of terminals (13).

22. Communications system, which comprises at least one network element (5) according to claim 17;
at least one network element (10); comprising
receiving means for receiving from another network element (5) packets to which data for a specific service was distributed at said other network element (5) upon receipt of said data for a specific service from a service provider (1-4), wherein each of said packets comprises a data flow identification information identifying all packets to which data for said specific service was distributed;
means for extracting said data flow identification information from each received packet containing such a data flow identification information;
means for forwarding the data for a specific service in accordance with said extracted information to a group of terminals (13); and
a group of terminals (13).
